(19) United States
(12) Patent Application Publication
(10) Pub. No.: US 2025/0296325 A1
(43) Pub. Date: Sep. 25, 2025

(54) LIQUID DISCHARGE APPARATUS, IMAGE FORMING APPARATUS, LIQUID DISCHARGE METHOD, AND STORAGE MEDIUM

(71) Applicants: Kouichi TAKAHASHI, Kanagawa (JP); Takahiro YOSHIDA, Kanagawa (JP)

(72) Inventors: Kouichi TAKAHASHI, Kanagawa (JP); Takahiro YOSHIDA, Kanagawa (JP)

(21) Appl. No.: 19/062,077

(22) Filed: Feb. 25, 2025

(30) Foreign Application Priority Data
Mar. 22, 2024 (JP) 2024-047081

(51) Int. Cl. B41J 2/045; B41J 2/21

(52) U.S. Cl. CPC B41J 2/04593; B41J 2/04581; B41J 2/2121

(57) ABSTRACT

A liquid discharge apparatus includes a liquid discharge head and circuitry. The liquid discharge head has multiple nozzles. The circuitry causes the liquid discharge head to discharge two or more types of the liquid droplets having at least: a first droplet; a second droplet; and a non-discharge droplet, to form an image according to an input gradation value of the image. Further, the circuitry causes the liquid discharge head to increase a first number of the multiple nozzles that discharge the first droplet in a second range while decreasing a second number of the multiple nozzles that discharge the non-discharge droplet with an increase in the input gradation value, and causes the liquid discharge head to keep a constant ratio of the second number of the multiple nozzles to a total number of the multiple nozzles in at least one part of the first range in the input gradation value.

### CROSS-REFERENCE TO RELATED APPLICATION

This patent application is based on and claims priority pursuant to 35 U.S.C. § 119(a) to Japanese Patent Application No. 2024-047081, filed on Mar. 22, 2024, in the Japan Patent Office, the entire disclosure of which is hereby incorporated by reference herein.

### BACKGROUND

### Technical Field

The present disclosure relates to a liquid discharge apparatus, an image forming apparatus, a liquid discharge method, and a storage medium storing a plurality of instructions.

### Related Art

A gradation expression technique is typically used to express the gradation of an image. A low gradation portion is expressed by a small dot size of small droplets. In an intermediate gradation portion, a ratio of the small dot size is reduced, and a medium dot size of medium droplets is mixed. In a high gradation portion, a ratio of the medium dot size is reduced, and a large dot size of large droplets is mixed.

### SUMMARY

The present disclosure described herein provides an improved liquid discharge apparatus including a liquid discharge head and circuitry. The liquid discharge head has multiple nozzles to discharge liquid droplets from the multiple nozzles on a medium to form an image on the medium. The circuitry causes the liquid discharge head to discharge two or more types of the liquid droplets having at least: a first droplet having a first discharge volume; a second droplet having a second discharge volume smaller than the first discharge volume; and a non-discharge droplet not discharged from the multiple nozzles, to form the image on the medium according to an input gradation value of the image. The input gradation value increases from a first range to a second range higher than the first range. Further, the circuitry causes the liquid discharge head to increase a first number of the multiple nozzles that discharge the first droplet in the second range in the input gradation value while decreasing a second number of the multiple nozzles that discharge the non-discharge droplet with an increase in the input gradation value, and causes the liquid discharge head to keep a constant ratio of the second number of the multiple nozzles to a total number of the multiple nozzles in at least one part of the first range in the input gradation value.

Further, the present disclosure described herein provides an improved liquid discharge method and a non-transitory storage medium storing a plurality of instructions which, when executed by one or more processors, causes the one or more processors to perform a method. The method (liquid discharge method) includes discharging liquid droplets from multiple nozzles on a medium to form an image on the medium and discharging two or more types of the liquid droplets having at least: a first droplet having a first discharge volume; a second droplet having a second discharge volume smaller than the first discharge volume; and a non-discharge droplet not discharged from the multiple nozzles, to form the image on the medium according to an input gradation value of the image. The input gradation value increases from a first range to a second range higher than the first range. The method further includes increasing a first number of the multiple nozzles that discharge the first droplet in the second range in the input gradation value while decreasing a second number of the multiple nozzles that discharge the non-discharge droplet with an increase in the input gradation value, and keeping a constant ratio of the second number of the multiple nozzles to a total number of the multiple nozzles in at least one part of the first range in the input gradation value.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a graph for explaining a gradation expression method according to a comparative example;

FIG. 2 is a perspective view of an image forming apparatus using a liquid discharge apparatus according to a first embodiment of the present disclosure, illustrating the interior thereof transparently;

FIG. 3 is a schematic plan view of the image forming apparatus of FIG. 2, according to the first embodiment;

FIG. 4A is a block diagram of a hardware configuration of the image forming apparatus of FIG. 2, according to the first embodiment;

FIGS. 4BA and 4BB are diagrams illustrating liquid droplets landed on a medium by the image forming apparatuses according to the comparative example and the first embodiment, respectively;

FIG. 5A is a graph for explaining a gradation expression method by a liquid discharge apparatus according to a first example;

FIG. 5B is another graph for explaining the gradation expression method of FIG. 5A by the liquid discharge apparatus according to the first example;

FIG. 6A is a table illustrating image quality when white pixels are filled with only small droplets;

FIG. 6B is a table illustrating image quality when white pixels are filled with only medium droplets;

FIG. 6C is a table illustrating image quality when white pixels are filled with only large droplets;

FIG. 7 is a graph for explaining a gradation expression method by a liquid discharge apparatus according to a second example;

FIG. 8 is another graph for explaining the gradation expression method of FIG. 7 by the liquid discharge apparatus according to the second example;

FIG. 9 is a graph for explaining a gradation expression method by a liquid discharge apparatus according to a third example;

FIG. 10 is another graph for explaining the gradation expression method of FIG. 9 by the liquid discharge apparatus according to the third example;

FIG. 11 is a graph for explaining a gradation expression method by a liquid discharge apparatus according to a fourth example;

FIG. 12 is another graph for explaining the gradation expression method of FIG. 11 by the liquid discharge apparatus according to the fourth example;

FIG. 13 is a graph for explaining a gradation expression method by a liquid discharge apparatus according to a fifth example;

FIG. 14 is another graph for explaining the gradation expression method of FIG. 13 by the liquid discharge apparatus according to the fifth example; and

FIG. 15 is a schematic view of an electrode manufacturing apparatus using a liquid discharge apparatus according to a second embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

In a comparative example, a low gradation portion is expressed by a small dot size of small droplets. In an intermediate gradation portion, a ratio of the small dot size is reduced, and a medium dot size of medium droplets is mixed. In a high gradation portion, a ratio of the medium dot size is reduced, and a large dot size of large droplets is mixed. As the number of droplets simultaneously discharged (i.e., discharged droplets) increases, airflows caused by the discharged droplets interfere with each other, and thus the discharged droplets may be deflected.

Such a deflection (i.e., a jetting deflection) becomes more significant as the distance from nozzles to a recording medium such as a sheet increases. For example, when satellites, which are minute droplets separated from the discharged droplets, are generated, the satellites are flown by the airflow and land on a medium, and thus unevenness such as a woodgrain may be generated. In the vicinity of the nozzles at the end of a liquid discharge head, the airflow, which affects the discharged droplets, is likely to be unevenly generated, and the landing position of the discharged droplets is easily shifted (i.e., the discharged droplet is easily deflected). In particular, when multiple liquid discharge heads are arranged to print an image, white streaks or black streaks are likely to occur at the joint between the liquid discharge heads.

In consideration of the balance of the configuration of the discharged droplets, a technique of using large, discharged droplets for the same gradation has been considered. In such a technique, only the largest droplets are discharged in the high gradation portion, and the number of non-discharge nozzles that do not discharge the liquid droplets is not increased (is decreased) from a low gradation portion toward the high gradation portion.

However, in the above-described configuration of the discharged droplets, the space between the discharged droplets is the same as the number of inputs, and the intervals between the discharged droplets are narrowed as a result only by simply changing the size of the discharged droplets, and thus the discharged droplets are easily affected by the airflow. Further, since two kinds of sizes of the discharged droplets are used for a given input level, the smaller discharged droplets are more likely to be affected by the airflow.

Embodiments of a liquid discharge apparatus, an image forming apparatus, a liquid discharge method, and a storage medium are described in detail below with reference to the accompanying drawings.

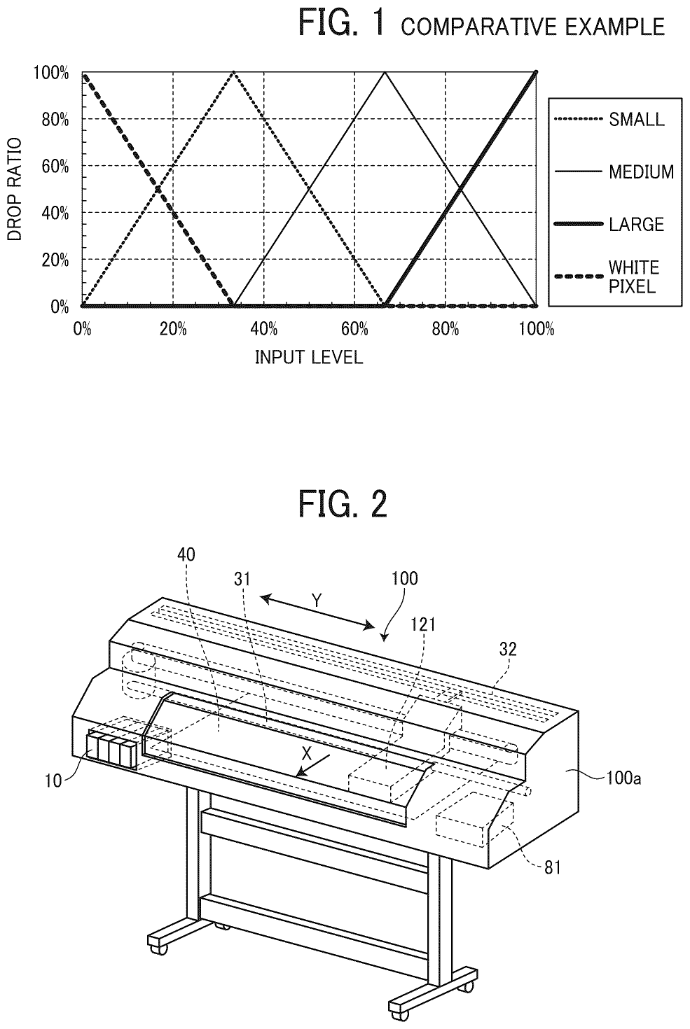

FIG. 1 is a graph for explaining a gradation expression method according to a comparative example. In FIG. 1, the vertical axis represents a drop ratio, and the horizontal axis represents an input level. The input level is an example of an input gradation value that indicates the level of density of an image to be formed (i.e., an image density). In grayscale, the input level of 0% indicates white (i.e., low or light gradation) and the input level of 100% indicates black (i.e., high or dark gradation). A drop ratio indicates a percentage of usage of discharged droplets (i.e., the droplets of each size discharged from a liquid discharge head) or dot sizes at a given input level. In each size, the drop ratio of 0% indicates that the droplets are not used, and the drop ratio of 100% indicates that the entire surface is filled with dots formed by the droplets. In explanatory legends of FIG. 1 and other drawings, “small” represents small droplets or a small dot size, “medium” represents medium droplets or a medium dot size, “large” represents large droplets or a large dot size, and “white pixel” represents pixels into which no liquid droplets are discharged. The white pixel refers to a non-discharge droplet not discharged from the nozzles.

For example, when the input level is 0%, the drop ratio of any of the small droplets, the medium droplets, and the large droplets is 0%, which indicates that no liquid droplets are discharged. Accordingly, the percentage of usage (drop ratio) of the white pixels is 100%. When the input level is 16.7%, the percentage of usage of the small droplets is 50%, and the percentage of usage of each of the medium droplets and the large droplets is 0%. Accordingly, the percentage of usage of the white pixels is 50%. When the input level is 50%, the percentage of usage of each of the small droplets and the medium droplets is 50%, and the percentage of usage of the large droplets is 0%. Thus, the percentage of usage of the white pixels is 0%.

In such a gradation expression method, the small droplets are used up to the drop ratio of 100%, and then the small droplets start to be replaced with the medium droplets. When the drop ratio of the medium droplets reaches 100%, the medium droplets start to be replaced with the large droplets. Accordingly, smooth gradation can be expressed.

However, the percentage of usage (drop ratio) of the white pixels is 0% at the input level of 33%. Accordingly, an airflow caused by the discharged droplets becomes large. When the distance from nozzles of the liquid discharge head to a recording medium is short, which is typically about 1 to 2 mm, the discharged droplets land on the recording medium before being affected by the airflow. For this reason, landing position deviation of droplets and jetting deflection of discharged droplets are unlikely to occur. However, when the distance from the nozzles to the recording medium is long, the landing position deviation of droplets or the jetting deflection of discharged droplets may occur.

In particular, when the size of droplets, such as the small droplets or the medium droplets, is relatively small, the droplets are more likely to be affected by the airflow. Accordingly, the landing position deviation of droplets and the jetting deflection of discharged droplets are more likely to occur.

### First Embodiment

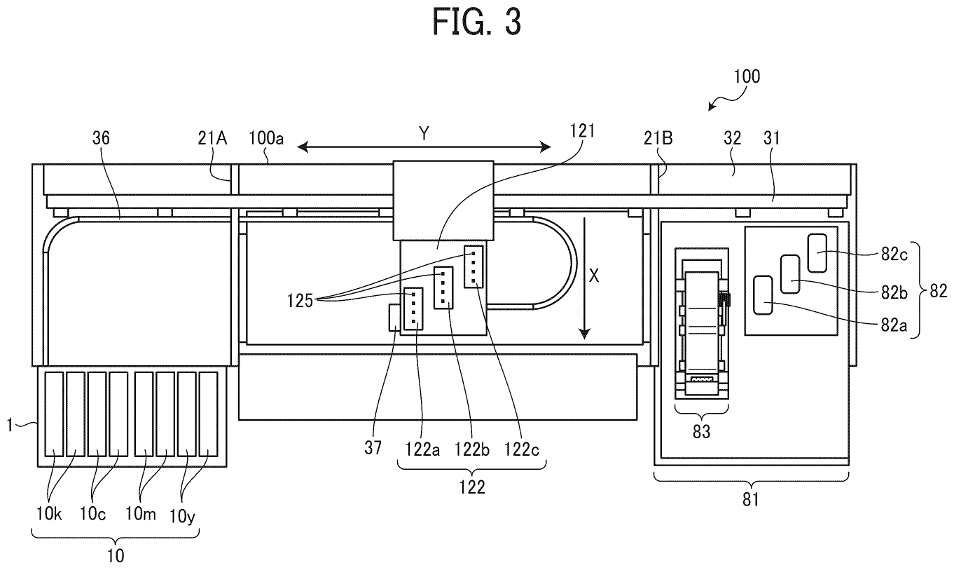

FIG. 2 is a perspective view of an image forming apparatus using a liquid discharge apparatus according to a first embodiment of the present disclosure, illustrating the interior thereof transparently. FIG. 3 is a schematic plan view of the image forming apparatus of FIG. 2, according to the first embodiment. As illustrated in FIGS. 2 and 3, an image forming apparatus 100 is a wide, serial-type inkjet recording apparatus.

In the present embodiment, the liquid discharge apparatus according to the present disclosure is applied to the wide, serial-type inkjet recording apparatus, but can be applied to any image forming apparatus such as a multifunction peripheral having at least two functions of a copy function, a printer function, a scanner function, and a facsimile function, a copier, a printer, a scanner, or a facsimile machine.

As illustrated in FIGS. 2 and 3, the image forming apparatus 100 includes side plates 21A and 21B on the left and right of an apparatus body 100a. A main guide rod 31 as a guide is laterally bridged between the side plates 21A and 21B. The image forming apparatus 100 includes a sub sheet metal guide 32. The main guide rod 31 and the sub sheet metal guide 32 slidably hold a carriage 121.

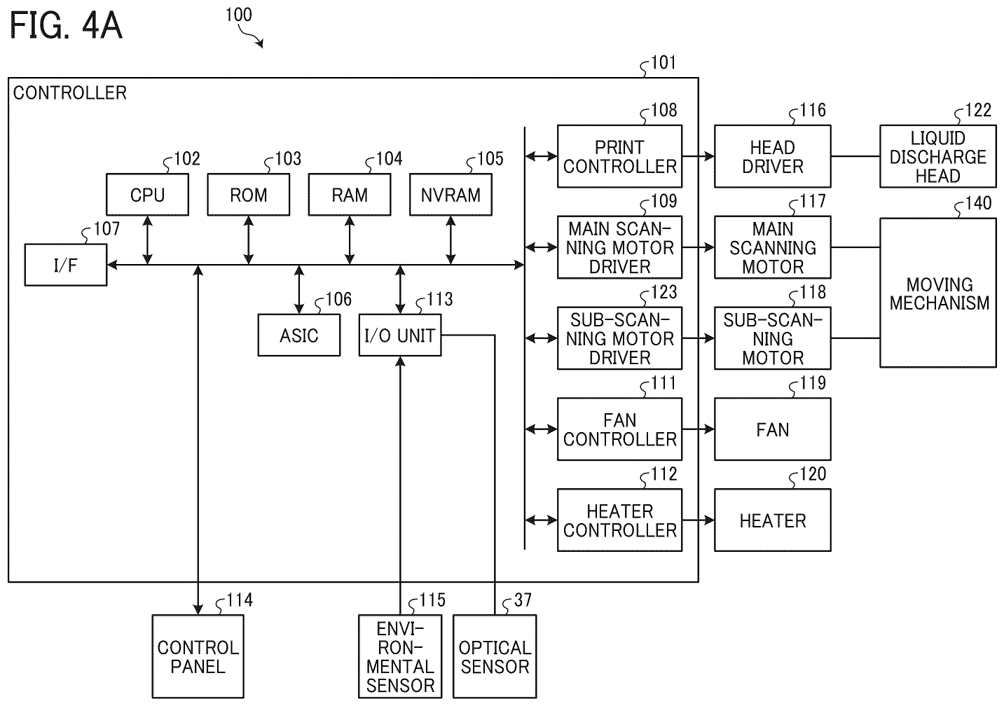

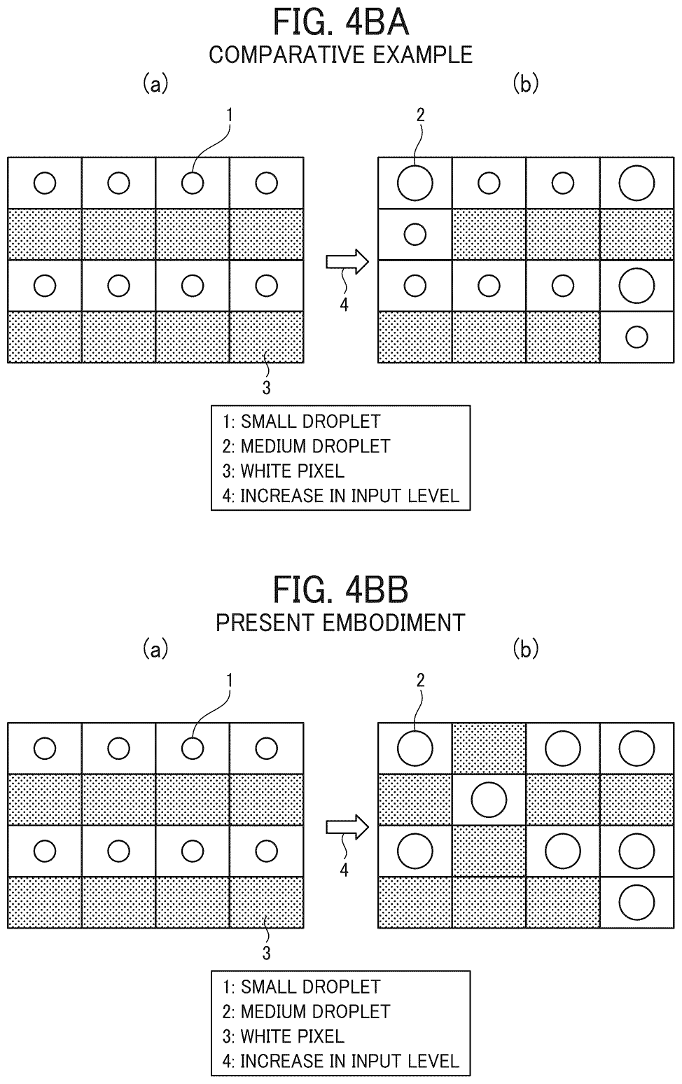

A main scanning motor 117 (see FIG. 4A) rotates a timing belt to move the carriage 121 in the direction indicated by arrow Y in FIGS. 2 and 3 (i.e., a main scanning direction). As a result, the carriage 121 moves relative to a medium 40. The movement of the carriage 121 may also be referred to as scanning. The carriage 121 is provided with an optical sensor 37 that detects an end of the medium 40 (end of a sheet).

The optical sensor 37 is an example of a reading unit that outputs a read signal of an image that has been formed on the medium 40 by the image forming apparatus 100. As the optical sensor 37, for example, a device that detects an image by reflection density and a camera that captures an image formed on the medium 40 can be used.

The carriage 121 includes heads 122a, 122b, and 122c that discharge ink droplets (liquid) of respective colors such as yellow (Y), cyan (C), magenta (M), black (K), orange (O), green (G), and clear (Cl) in accordance with ink cartridges 10 mounted on the image forming apparatus 100. These three heads 122a, 122b, and 122c may be collectively referred to as “liquid discharge heads 122,” each of which may be referred to as a “liquid discharge head 122” unless distinguished.

A sub-scanning motor 118 (see FIG. 4A) rotates a conveyance roller to move the medium 40 in a sub-scanning direction (the direction indicated by arrow X in FIGS. 2 and 3) substantially orthogonal to the main scanning direction (Y direction). As a result, the medium 40 moves relative to the liquid discharge head 122. However, the main scanning direction (Y direction) is not necessarily substantially orthogonal to the sub-scanning direction (X direction), and may only intersect the sub-scanning direction.

Each of the heads 122a, 122b, and 122c includes a nozzle array including multiple nozzles 125 arrayed in the sub-scanning direction (X direction). The heads 122a, 122b, and 122c are mounted on the carriage 121 so as to discharge ink droplets downward (Z direction) from the nozzles 125. The Z direction is orthogonal to the X direction and the Y direction, i.e., the direction orthogonal to the surface of the paper on which FIG. 3 is drawn. The nozzles 125 are formed on a lower face (i.e., a nozzle face) of each of the heads 122a, 122b, and 122c. Accordingly, the nozzles 125 are not actually seen from above in the Z direction in FIG. 3, but depicted in FIG. 3 for convenience of explanation. The heads 122a, 122b, and 122c overlap each other in the sub-scanning direction (X direction). The carriage 121 is provided with sub tanks for supplying ink of the respective colors to the heads 122a, 122b, and 122c.

The term “liquid discharge head (head)” used herein is a functional component to discharge liquid through the nozzles. Liquid to be discharged from the liquid discharge head 122 is not limited to a particular liquid as long as the liquid has a viscosity or surface tension to be discharged from the liquid discharge head 122. However, preferably, the viscosity of the liquid is not greater than 30 millipascal-second (mPa's) under ordinary temperature and ordinary pressure or by heating or cooling. Examples of the liquid to be discharged include a solution, a suspension, or an emulsion including, for example, a solvent, such as water or an organic solvent; a colorant, such as dye or pigment; a functional material, such as a polymerizable compound, a resin, or a surfactant; a biocompatible material, such as deoxyribonucleic acid (DNA), amino acid, protein, or calcium; and an edible material, such as a natural colorant. Such a solution, a suspension, or an emulsion can be used for, e.g., inkjet ink; surface treatment liquid; a liquid for forming an electronic element component, a light-emitting element component, or an electronic circuit resist pattern; or a material solution for three-dimensional fabrication.

Examples of an energy source of the liquid discharge head for generating energy to discharge liquid include a pressure generator such as a piezoelectric actuator (a laminated piezoelectric element or a thin-film piezoelectric element).

The pressure generator used in the liquid discharge head is not limited to a particular type of pressure generator. In addition to the above-described piezoelectric actuator (which may use a laminated piezoelectric element), for example, a thermal actuator using a thermoelectric transducer such as a thermal resistor, and an electrostatic actuator including a diaphragm and opposed electrodes can be used.

The image forming apparatus 100 includes a cartridge mount 1 on which ink cartridges 10y, 10c, 10m, and 10k for the respective colors are detachably mounted. The ink cartridges 10y, 10c, 10m, and 10k may be collectively referred to as the “ink cartridges 10,” each of which may be referred to as an “ink cartridge 10” unless distinguished.

Ink in the ink cartridge 10 is supplied to the sub tank of the carriage 121 through a supply tube 36 of each color by a supply pump unit. The supply pump unit and the supply tube 36 construct a supply mechanism. Examples of the ink cartridge 10 may include an ink cartridge for white ink.

The image forming apparatus 100 includes a maintenance mechanism 81 in a non-print area on one end of the range of movement of the carriage 121 in the main scanning direction (Y direction). The maintenance mechanism 81 maintains and recovers the condition of the nozzles 125 of the liquid discharge head 122.

The maintenance mechanism 81 includes caps 82a, 82b, and 82c for covering the nozzle faces of the liquid discharge heads 122 and a wiper unit 83 for wiping the nozzle faces. The caps 82a, 82b, and 82c may be collectively referred to as “caps 82,” each of which may be referred to as a “cap 82” unless distinguished. A replaceable waste liquid tank that stores waste liquid caused by maintenance and recovery operations is disposed below the maintenance mechanism 81 for the liquid discharge head 122.

The liquid discharge unit refers to the liquid discharge head 122 integrated with functional components or mechanisms, i.e., an assembly of components related to liquid discharge. For example, the liquid discharge unit includes a combination of the liquid discharge head 122 with at least one of a head tank (i.e., the sub tanks of the carriage 121), the carriage 121, the supply mechanism, the maintenance mechanism 81, or a main-scanning moving mechanism.

The above integration may be achieved by, for example, a combination in which the liquid discharge head 122 and a functional part(s) are fixed to each other through, e.g., fastening, bonding, or engaging, and a combination in which one of the liquid discharge head 122 and the functional part(s) is movably held by the other. The liquid discharge head 122 and the functional part(s) or mechanism(s) may be detachably attached to each other.

For example, the liquid discharge head 122 and the head tank are integrated to form the liquid discharge unit as a single unit. Alternatively, the liquid discharge head 122 and the head tank coupled (connected) with, for example, a tube may construct the liquid discharge unit as a single unit. A unit including a filter may further be added to a portion between the head tank and the liquid discharge head 122 of the liquid discharge unit.

In another example, the liquid discharge unit may be an integrated unit in which the liquid discharge head 122 is integrated with the carriage 121.

As yet another example, the liquid discharge unit is a unit in which the liquid discharge head 122 and the main-scanning moving mechanism are combined into a single unit. The liquid discharge head 122 is movably held by the main guide rod 31 which is a guide forming a part of the main-scanning moving mechanism. The liquid discharge unit may include the liquid discharge head 122, the carriage 121, and the main-scanning moving mechanism that are integrated as a single unit.

In another example, the cap 82 that forms a part of the maintenance mechanism 81 is fixed to the carriage 121 mounting the liquid discharge head 122 so that the liquid discharge head 122, the carriage 121, and the maintenance mechanism 81 are integrated as a single unit to form the liquid discharge unit.

Further, in still another example, the liquid discharge unit includes the supply tube 36 connected to the liquid discharge head 122 mounting the head tank (sub tank of the carriage 121) or a channel component so that the liquid discharge head 122 and the supply mechanism are integrated as a single unit. Through the supply tube 36, the liquid in a liquid storage source is supplied to the liquid discharge head 122.

Examples of the main-scanning moving mechanism include the main guide rod 31 as a guide alone. Examples of the supply mechanism include the supply tube 36 alone and the cartridge mount 1 alone.

FIG. 4A is a block diagram of a hardware configuration of the image forming apparatus according to the first embodiment. As illustrated in FIG. 4A, the image forming apparatus 100 includes a controller 101, a control panel 114, an environmental sensor 115, an optical sensor 37, a head driver 116, the main scanning motor 117, the sub-scanning motor 118, a fan 119, a heater 120, the liquid discharge head 122, and a moving mechanism 140. In the present embodiment, the controller 101, the head driver 116, and the liquid discharge head 122 function as an example of a liquid discharge apparatus.

As illustrated in FIG. 4A, the controller 101 includes a central processing unit (CPU) 102, a read-only memory (ROM) 103, a random-access memory (RAM) 104, a non-volatile memory (NVRAM: non-volatile RAM) 105, an application-specific integrated circuit (ASIC) 106, an interface (I/F) 107, a print controller 108, a main scanning motor driver 109, a sub-scanning motor driver 123, a fan controller 111, a heater controller 112, and an input/output (I/O) unit 113. The controller 101 may include a configuration other than the above.

The CPU 102, the ROM 103, the RAM 104, the non-volatile memory 105, the ASIC 106, the I/F 107, the print controller 108, the main scanning motor driver 109, the sub-scanning motor driver 123, the fan controller 111, the heater controller 112, and the I/O unit 113 are connected to each other via, for example, a bus so as to communicate with each other.

The CPU 102 controls the operation of the entire image forming apparatus 100. Specifically, the CPU 102 executes programs stored in, for example, the ROM 103 to implement functions of the above configuration.

The ROM 103 stores the programs to be executed by the CPU 102 and other fixed data. The RAM 104 temporarily stores image data and other data. The non-volatile memory 105 can retain data even while a power supply of the image forming apparatus 100 is shut off. The ASIC 106 is a circuit that performs image processing, such as various signal processing and sorting, and processing of input and output signals for controlling the entire image forming apparatus 100.

The I/F 107 is an interface circuit that transmits and receives data and signals to and from a host. Specifically, the I/F 107 receives print data (image data) generated by a printer driver of the host such as a data processor, an image reading device, or an imaging device via a cable or a network. In other words, the printer driver of the host may generate and output the image data to the controller 101.

The print controller 108 is a circuit that generates a drive waveform for driving the liquid discharge head 122 and outputs the print data accompanied by various data to the head driver 116. The pressure generator of the liquid discharge head 122 is selectively driven based on the print data and generates pressure to cause the liquid discharge head 122 to discharge liquid (ink) from the nozzles.

The main scanning motor driver 109 is a circuit that drives the main scanning motor 117. The sub-scanning motor driver 123 is a circuit that drives the sub-scanning motor 118. The fan controller 111 is a circuit that controls the output of the fan 119 to blow air at a predetermined temperature and air volume.

The heater controller 112 is a circuit that controls the heater 120 to a set temperature. The I/O unit 113 is a circuit that acquires data from the environmental sensor 115 and extracts data for controlling each unit of the image forming apparatus 100. The I/O unit 113 also receives detection signals from various sensors (e.g., the optical sensor 37) other than the environmental sensor 115.

The control panel 114 is a device for inputting and displaying various kinds of data such as a resolution specified by a user. The control panel 114 is connected to, for example, the CPU 102 via the bus of the controller 101 to communicate with each other.

The environmental sensor 115 is a sensor that detects, for example, the ambient temperature and ambient humidity. The environmental sensor 115 is connected to the I/O unit 113 of the controller 101.

The head driver 116 is a circuit that selectively applies drive pulses forming the drive waveform given from the print controller 108 to the pressure generator of the liquid discharge head 122 based on the input image data (e.g., dot pattern data) to drive the liquid discharge head 122. The head driver 116 is connected to the print controller 108 of the controller 101. The discharge volume of ink droplets (liquid) is controlled by, for example, controlling the amplitude of the drive waveform input to the pressure generator of the liquid discharge head 122, but the discharge volume may be controlled using other parameters.

The main scanning motor 117 is a device that is driven to rotate the timing belt to move the carriage 121 including the liquid discharge head 122 in the main scanning direction (the direction indicated by arrow Y). The main scanning motor 117 is connected to the main scanning motor driver 109 of the controller 101.

The sub-scanning motor 118 is a device that is driven to operate the conveyance roller as a conveyor to convey the medium 40, which is an object onto which liquid (ink) is discharged by the liquid discharge head 122, in the sub-scanning direction (X direction). The sub-scanning motor 118 is connected to the sub-scanning motor driver 123 of the controller 101.

The moving mechanism 140 moves the liquid discharge head 122 and the medium 40 relative to each other. The moving mechanism 140 includes the main guide rod 31, the sub sheet metal guide 32, and the carriage 12 to construct the main-scanning moving mechanism, and further includes the conveyance roller.

The moving mechanism 140 moves the liquid discharge head 122 and the medium 40 relative to each other in the main scanning direction (Y direction) by, for example, the main guide rod 31, the sub sheet metal guide 32, and the carriage 121. The moving mechanism 140 moves the liquid discharge head 122 and the medium 40 relative to each other in the sub-scanning direction (X direction) by, for example, the conveyance roller that conveys the medium 40. In the present embodiment, the relative movement in the sub-scanning direction (X direction) by the moving mechanism 140 is intermittent movement. The intermittent movement means that the moving mechanism 140 alternately moves and stops at least one of the liquid discharge head 122 or the medium 40 relative to the other.

The fan 119 is driven to accelerate the convection of air inside the image forming apparatus 100 so as to prevent the temperature from rising excessively due to the accumulation of warmed air in an upper portion of the image forming apparatus 100. The fan 119 is connected to the fan controller 111 of the controller 101.

Features of operations of the image forming apparatus 100 (an example of a liquid discharge apparatus) will be described below.

The liquid discharge head 122 is an example of a liquid discharge head that can discharge two or more types of liquid droplets (e.g., ink droplets) having different sizes. The controller 101 controls the head driver 116 to discharge only the largest droplet (e.g., the large droplets) in a high gradation portion (e.g., a first range) of the input gradation value (e.g., the input level) input to the liquid discharge head 122. The controller 101 as circuitry is an example of a controller. The controller 101 causes the liquid discharge head 122 to include at least one portion in which a ratio (i.e., a non-discharge nozzle ratio) of non-discharge nozzles, which do not discharge the liquid droplets among the nozzles of the liquid discharge head 122, does not increase from a low gradation portion (e.g., a second range) toward the high gradation portion (range) of the input gradation value and a slope of the ratio of non-discharge nozzles does not change. Thus, even when the discharge volume of the liquid droplets is the same, the wide intervals between the discharged droplets can be provided by increasing the percentage of usage of the large droplets (corresponding to a first number). As a result, the deterioration of the image quality due to the airflow can be reduced. In the present embodiment, an example of the controller is implemented by the controller 101 outside the liquid discharge head 122, but may be implemented inside the liquid discharge head 122.

The controller 101 may not decrease a discharged droplet amount ratio, which is an adhesion amount of liquid droplets per unit area or the image density, with an increase in the input gradation value.

The controller 101 may cause the liquid discharge head 122 to discharge the smallest droplet (e.g., the small droplets) only at the input gradation value of 20% or less.

The controller 101 may cause the liquid discharge head 122 to discharge only the smallest droplet at the input gradation value of 5% or less.

The liquid discharge head 122 may discharge three or more types of liquid droplets having different sizes (e.g., the small droplets, the medium droplets, and the large droplets). The controller 101 may cause the second smallest droplet (e.g., the medium droplets) to be discharged at the input gradation value of 20% or less.

The controller 101 may cause at least one portion of the portions in which the slope of the non-discharge nozzle ratio does not change in the liquid discharge head 122 to be present at the input gradation value of 20% or less.

Further, the controller 101 may cause two portions of the portions in which the slope of the non-discharge nozzle ratio does not change in the liquid discharge head 122 to be present at the input gradation value of 40% or less, and causes one of the two portions to be present at the input gradation value of 20% or less.

FIGS. 4BA and 4BB are diagrams illustrating liquid droplets landed on a medium by the image forming apparatuses according to the comparative example and the first embodiment, respectively. The diagram in a part (a) of FIG. 4BA and the diagram in a part (a) of FIG. 4BB are the same and illustrate an image formed on the medium. In the part (a) of each of FIGS. 4BA and 4BB, the image has 4×4 pixels, the small droplets are landed in 8 pixels, and the remaining 8 pixels are white pixels into which no liquid droplets are landed. When the input level is increased indicated by blank arrows 4 in FIG. 4BA, the small droplets are simply replaced with the medium droplets to increase the image density, and further, the small droplets are added to enhance graininess in the comparative example. Accordingly, when the input level is increased, a void ratio of the pixels of the image is decreased. In other words, the number of white pixels (i.e., a second number) is decreased as illustrated in a part (b) of FIG. 4BA.

In the present embodiment, the controller 101 replaces the small droplets with the medium droplets having a larger volume than the total volume of the small droplets and does not add the small droplets. As a result, the void ratio is not changed. In other words, the number of white pixels is not changed as illustrated in a part (b) of FIG. 4BB. The medium droplets are less likely to be affected (deflected) by the airflow. Accordingly, the droplets can be landed closer to a desired landing position in the part (b) of FIG. 4BB than in the part (b) of FIG. 4BA. In addition, the intervals between the droplets are wider in the part (b) of FIG. 4BB than in the part (b) of FIG. 4BA.

### First Example

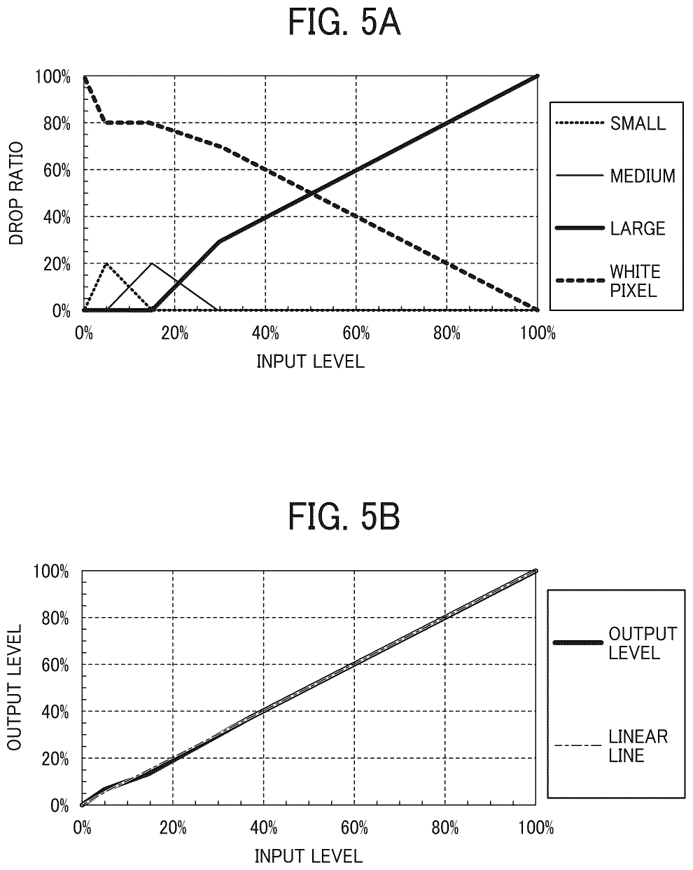

FIGS. 5A and 5B are graphs for explaining a gradation expression method by a liquid discharge apparatus according to a first example. In FIG. 5A, the vertical axis represents the drop ratio, and the horizontal axis represents the input level. In FIG. 5B, the vertical axis represents an output level, and the horizontal axis represents the input level. The output level indicates a density of an image that has been formed on the medium. In the present example, the small droplet has a volume of X1 pico-liter (pL), the medium droplet has a volume of Y1 pL, and the large droplet has a volume of Z1 pL. In this example, X1 is less than Y1, and Y1 is less than Z1.

The controller 101 keeps the percentage of usage (i.e., the drop ratio) of the small droplets low and starts using the medium droplets from the low input level of 5%. The controller 101 decreases the percentage of usage of the small droplets from the input level of 5% at which the medium droplets start to be used. In other words, the controller 101 causes the liquid discharge head 122 to discharge the small droplets only at the input gradation value of 20% or less. The controller 101 increases the percentage of usage of the medium droplets up to the input level of 15%. Accordingly, the number of discharge nozzles from which the liquid droplets are discharged can be reduced by using the medium droplets to obtain the same print density obtained by only the small droplets. In addition, the ratio of non-discharge nozzles from which liquid droplets are not discharged (i.e., non-discharge nozzle ratio) can be kept at a high level of 80% despite the increase in print density, and the landing position deviation and the jetting deflection of discharged droplets can be reduced compared to a droplet configuration in which the non-discharge nozzle ratio is decreased below 80%.

Similarly, the controller 101 keeps the percentage of usage of the medium droplets low and decreases the percentage of usage of the medium droplets from the input level of 15% at which the large droplets start to be used. The controller 101 stops using the medium droplets at the input level of 30% before the input level reaches 100%. As illustrated in FIG. 5B, when the percentage of usage is determined, preferably, the output level is substantially linearly changed with respect to the input level. However, the output level may be slightly deviated from a linear line so that the non-discharge nozzle ratio is kept unchanged, but the output level is increased with an increase in the input level. In other words, the controller 101 causes the liquid discharge head 122 to discharge only the large droplets in a high gradation portion of the input level. The controller 101 does not increase the non-discharge nozzle ratio from the low gradation to the high gradation of the input level, and keeps a slope of non-discharge nozzle ratio relative to the input level unchanged in at least one part of a range of the input level. In other words, the controller 101 cause the liquid discharge head 122 to keep a constant ratio of the second number of multiple nozzles to a total number of the multiple nozzles that discharge the non-discharge droplet in at least one part of the first range in the input gradation value.

In this case, the output level may indicate the adhesion amount of liquid droplets per unit area, or may indicate the image density. The linear relationship between the output level and the input level controlled by the controller 101 can minimize the influence of a gradation jump in, for example, a y curve and color matching for determining the final color tone of an image. In other words, the controller 101 does not decrease the discharged droplet amount ratio, which corresponds to the adhesion amount of liquid droplets per unit area or the image density, with an increase in the input level.

Due to the percentages of usage of the large, medium, and small droplets as described above, the white pixels remain at any input level except for 100%. In addition, the ratio of the white pixels is kept unchanged at the low print density. As a result, the number of liquid droplets to be simultaneously discharged can be efficiently reduced, and the influence of a discharge airflow caused by the discharged droplets can be reduced. Accordingly, the landing position deviation, the jetting deflection, and white streaks and black streaks at the joint of the heads can be prevented.

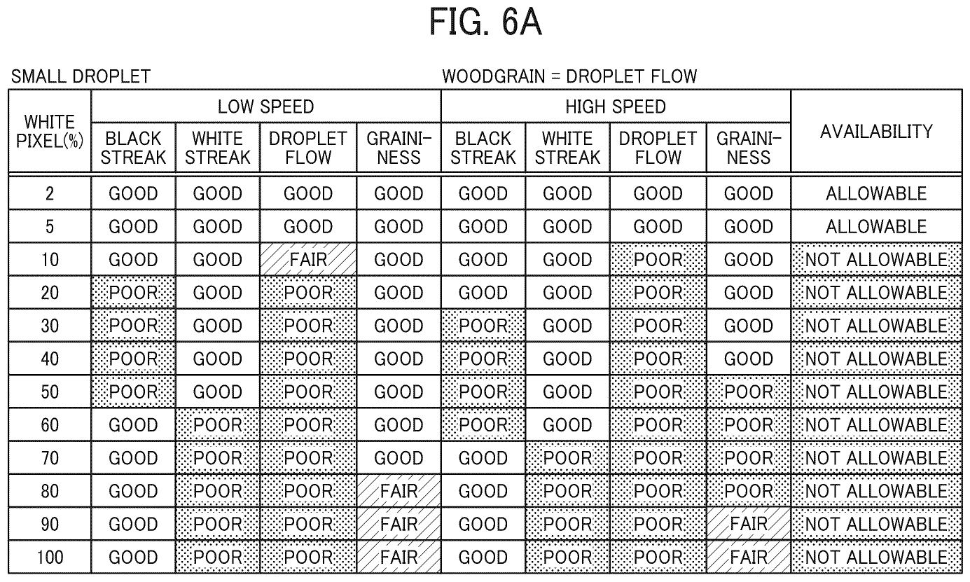

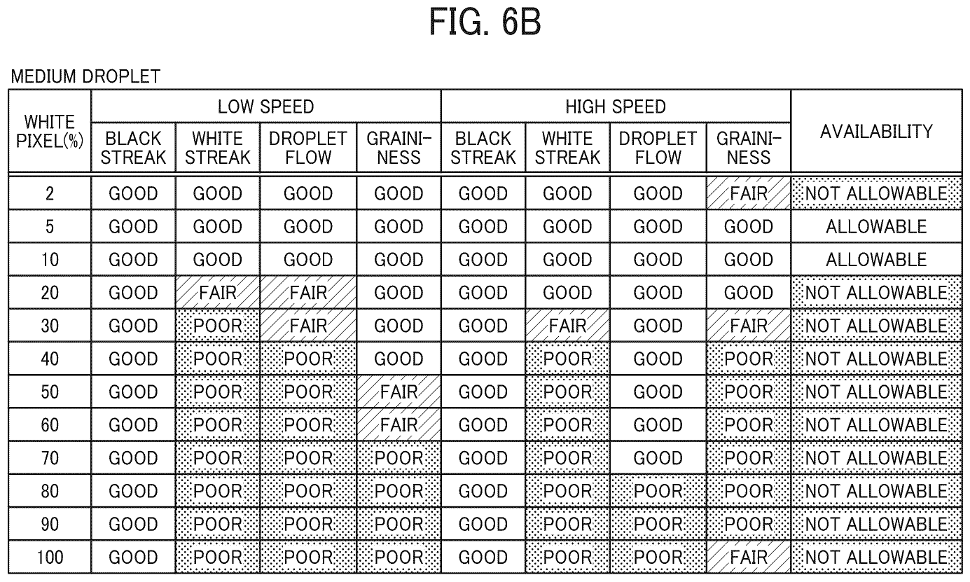

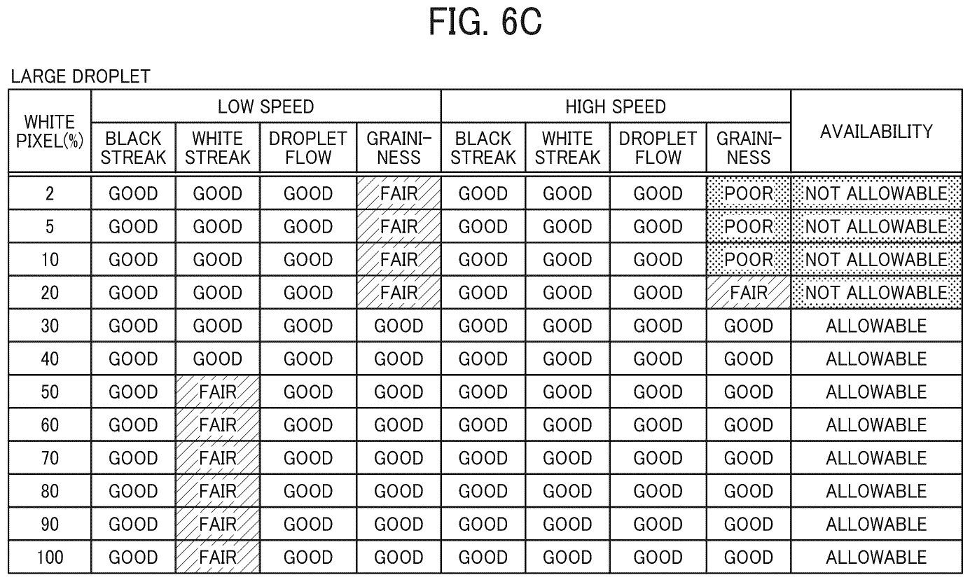

FIG. 6A is a table illustrating the image quality when the white pixels are filled with only the small droplets. FIG. 6B is a table illustrating the image quality when the white pixels are filled with only the medium droplets. FIG. 6C is a table illustrating the image quality when the white pixels are filled with only the large droplets.

The appearance of, for example, black streaks according to the size of liquid droplets will be described below. FIGS. 6A to 6C illustrate the appearance of black streaks and white streaks at the joints of the liquid discharge heads 122, droplet flow (i.e., woodgrain), and graininess.

As illustrated in 6A, although the image quality depends on print conditions, the small droplets are preferably used in the range of the white pixels of 0 to 10% to obtain a desired image quality with only the small droplets. As illustrated in 6B, the medium droplets are preferably used in the range of the white pixels less than 20% to obtain the desired image quality with only the medium droplets. As illustrated in 6C, preferably, the large droplets are not used in the low white pixels to obtain the well-balanced image quality.

Accordingly, in the present embodiment, the controller 101 replaces liquid droplets with larger droplets from the low gradation toward the high gradation to fill the white pixels. Accordingly, printing can be performed under good conditions regarding the streaks at the joint of the liquid discharge heads 122, the droplet flow, and the graininess.

### Second Example

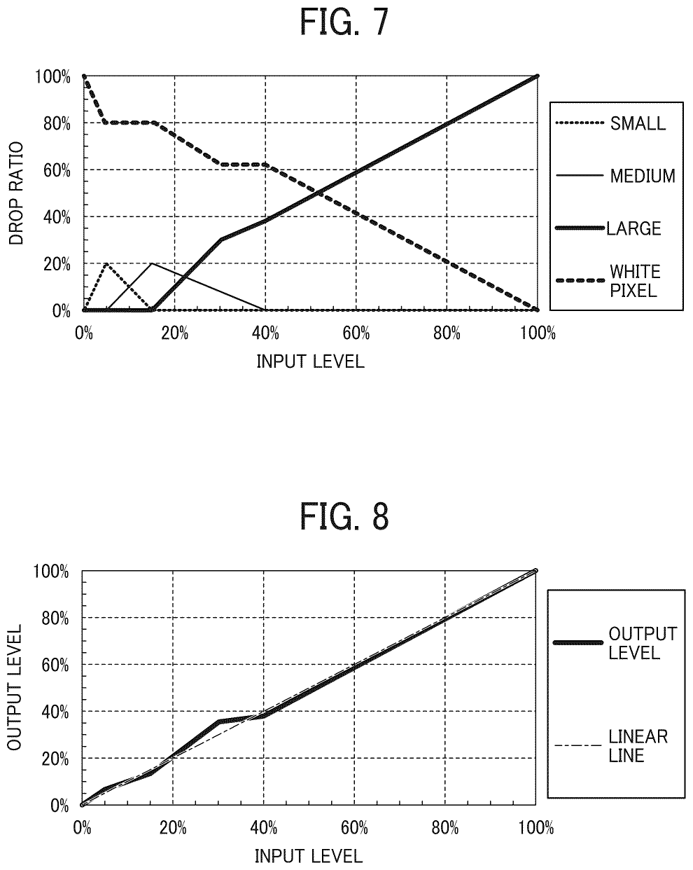

FIGS. 7 and 8 are graphs for explaining a gradation expression method by a liquid discharge apparatus according to a second example. In FIG. 7, the vertical axis represents the drop ratio, and the horizontal axis represents the input level. In FIG. 8, the vertical axis represents the output level, and the horizontal axis represents the input level.

The controller 101 keeps the slope of the ratio of the white pixels unchanged in a first region in which the small droplets are replaced with the medium droplets, similarly to the first example. In other words, the controller 101 adds the medium droplets before the jetting deflection of the small droplets becomes conspicuous, and uses the small droplets only in the range in which the black streaks or white streaks due to the jetting deflection of the small droplets do not occur. The controller 101 causes the liquid discharge head 122 to discharge only the small droplets at the input level of 5% or less. The second example is different from the first example in that the controller 101 keeps the slope of the ratio of the white pixels unchanged in a second region in which the medium droplets are replaced with the large droplets.

The controller 101 starts adding the large droplets from when the ratio of the medium droplet is the largest, and then keeps the slope of the ratio of the white pixels unchanged in the second region. The controller 101 uses the medium droplets in the range in which the white streaks or black streaks are not conspicuous, and changes the print density by the large droplets. The large droplets are likely to make the white streaks or black streaks inconspicuous as compared with the small droplets and the medium droplets. As a result, an excellent image can be obtained.

In the first example, the number of the white pixels is kept as high as possible in a gradation of 20% or less. When the gradation of 20% or more is formed only by the small droplets, the white streaks or black streaks occurs at 20% or more. The controller 101 does not form the gradation of 20% or more by the small droplets to obtain a desired image. In other words, the controller 101 sets at least one range in which the slope of the non-discharge nozzle ratio is unchanged in the liquid discharge head 122 at the input level of 20% or less. In this case, the controller 101 sets two ranges in which the slope of the non-discharge nozzle ratio is unchanged in the liquid discharge head 122 at the input level of 40% or less, and sets one of the two ranges at the input level of 20% or less.

In the present example, the controller 101 does not decrease the ratio of the white pixels as much as possible even in the gradation of the middle range (e.g., 15 to 40%). Even when gradation is formed only by the medium droplets, the white streaks or black streaks increase beyond the percentage of usage of 20%, as in the case of the small droplets. Accordingly, the controller 101 assigns the droplet configuration (i.e., the drop ratio) to the small, medium, and large droplets so that the percentage of usage of the medium droplets does not exceed 20% even in the medium range. The droplet configuration is the percentages of usage of the small droplets, the medium droplets, and the large droplets.

Although the output level is slightly deviated from the linear line with respect to the input level, the output level constantly increases with an increase in the input level. As a result, the gradation is not reversed. The influence on an image, such as the white streaks and black streaks, due to the landing position deviation or the jetting deflection changes depending on liquid (e.g., ink) and a recording medium to be used, the distance from the nozzles to the recording medium, or a printing speed. By reducing the percentages of usage of the small droplets and the medium droplets, the influence of the landing position deviation and the jetting deflection can be reduced, but the graininess of the image is likely to deteriorate. For this reason, it is necessary, under some printing conditions, to add fine adjustments and take a balance between the influence on the image and the graininess of the image.

### Third Example

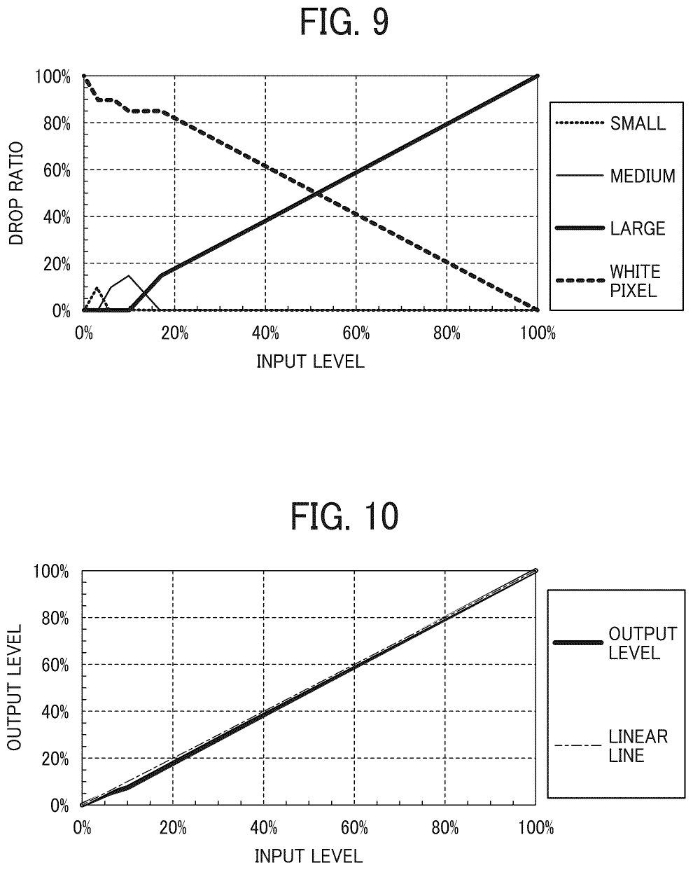

FIGS. 9 and 10 are graphs for explaining a gradation expression method by a liquid discharge apparatus according to a third example. In FIG. 9, the vertical axis represents the drop ratio, and the horizontal axis represents the input level. In FIG. 10, the vertical axis represents the output level, and the horizontal axis represents the input level. In this example, the volumes of the medium droplet and the large droplet are increased to increase the ratio of the white pixels. The small droplet has the volume of X1 pL, the medium droplet has a volume of Y2 pL, and the large droplet has a volume of Z2 pL. In this example, Y2 is more than Y1, and Z2 is more than Z1.

In this example, as illustrated in FIG. 9, the controller 101 keeps the percentage of usage of the small droplets lower than the first example and uses the small droplets with the maximum percentage of usage of 10% at the input level of 3%.

The controller 101 starts using the medium droplets from the input level of 3% at which the small droplets are used with the maximum percentage of usage. The controller 101 use the medium droplets with the droplet configuration of 10% at the input level of 6% and increases the droplet configuration to 15% toward the input level of 10%. The controller 101 decreases the droplet configuration to 0% of toward the input level of 17%. Beyond the input level of 17%, the controller 101 uses only the large droplets. In other words, the controller 101 causes the medium droplet to be discharged at the input level of 20% or less.

With the droplet configuration described above, the non-discharge nozzle ratio can be kept more than 80% as compared with the first example. In other words, the controller 101 increases the ratio of the white pixels in the low print density where the influence of the landing position deviation or the jetting deflection is most likely to appear in the image quality to obtain an image with few white streaks or black streaks.

Further, as illustrated in FIG. 10, the output level is substantially linearly changed with respect to the input level to form a smooth gradation pattern. In the second example, the medium droplets are used up to the high input level, and thus the output level with respect to the input level is slightly deviated from the linear line, but in the third example, the small and medium droplets are used up to the input level of 17%, and thus the gradation pattern can be formed smoother than the second example.

### Fourth Embodiment

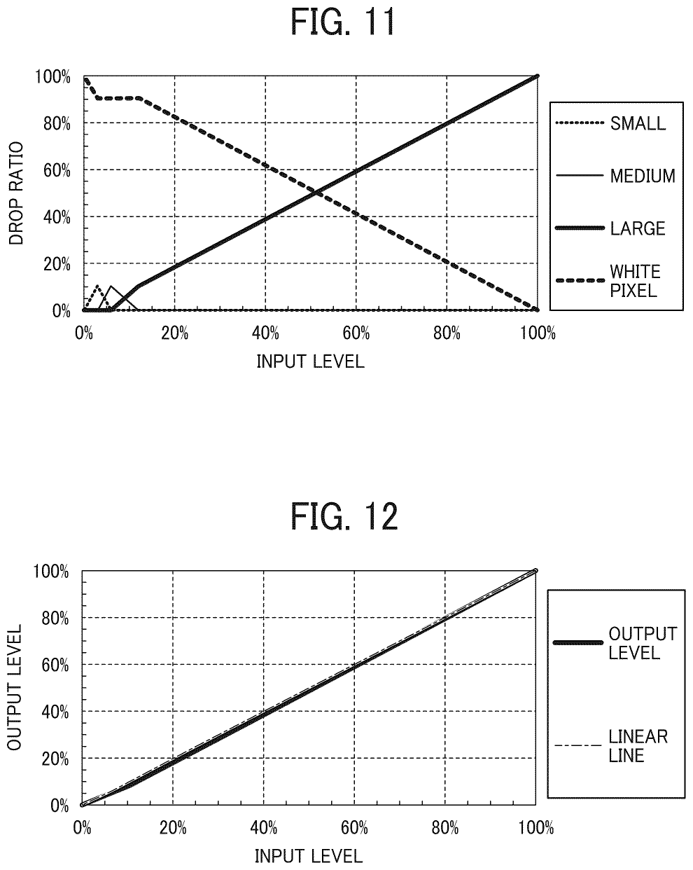

FIGS. 11 and 12 are graphs for explaining a gradation expression method by a liquid discharge apparatus according to a fourth example. In FIG. 11, the vertical axis represents the drop ratio, and the horizontal axis represents the input level. In FIG. 12, the vertical axis represents the output level, and the horizontal axis represents the input level.

In this example, the volume of the small droplet is increased larger than the third example and a range of usage for the medium droplets is narrowed to increase the ratio of the white pixels. The small droplet has a volume of X2 pL, and similarly to the third example, the medium droplet has the volume of Y2 pL, and the large droplet has the volume of Z2 pL. In this example, X2 is more than X1 and less than Y1.

As illustrated in FIG. 11, the controller 101 uses the small droplets with the maximum drop ratio of 10% at the input level of 3%, as in the third embodiment. Since the volume of the small droplet is slightly larger than the third example, the gradation is slightly smoother than that in the third embodiment. The controller 101 starts using the medium droplets from the input level of 3% and uses the medium droplets with the maximum drop ratio of 10% at the input level of 6%. The maximum drop ratio of the medium droplets is the same as that of the small droplets. The controller 101 keeps the percentage of usage of the medium droplets low and starts using the large droplet from the input level of 6%. Further, the controller 101 stops using the medium droplets at the input level of 12% and uses only the large droplets at input level of 12% or more. Such a droplet configuration can make the non-discharge nozzle ratio 90% in the range where small and medium droplets are used, and an image in which the white streaks or black streaks are less likely to occur can be obtained. Further, as illustrated in FIG. 12, the output level is more linearly changed with respect to the input level than the third example to form a smooth gradation pattern.

### Fifth Example

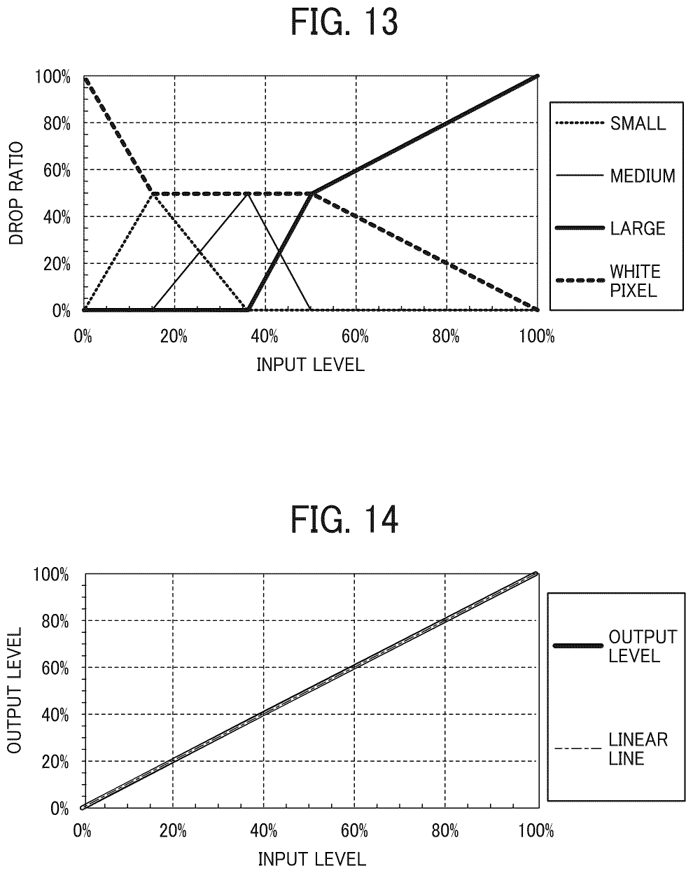

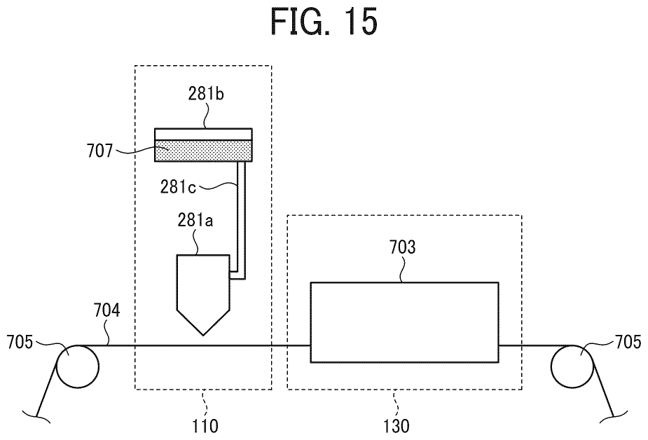

FIGS. 13 and 14 are graphs for explaining a gradation expression method by a liquid discharge apparatus according to a fifth example. In FIG. 13, the vertical axis represents the drop ratio, and the horizontal axis represents the input level. In FIG. 14, the vertical axis represents the output level, and the horizontal axis represents the input level. In this example, the volume of the large droplet is increased to increase the ratio of the white pixels. The small droplet has the volume of X2 pL, the medium droplet has the volume of Y2 pL, and the large droplet has a volume of Z3 pL. In this example, Z3 is more than Z2.

As illustrated in FIG. 13, the controller 101 uses the small droplets with the maximum percentage of usage of 50% at the input level of 15% to enhance graininess. The controller 101 decreases the percentage of usage of the small droplets from the input level of 15% to make the white streaks and black streaks inconspicuous. The controller 101 starts using the medium droplets from the input level of 15% at which the percentage of usage of the small droplets is maximized, and increases the drop ratio of the medium droplets up to 50% toward the input level of 36% to enhance graininess in the intermediate print density. The controller 101 starts using the large droplets from the input level of 36% at which the percentage of usage of the medium droplets is maximized, uses the large droplets with the percentage of usage of 50% at the input level of 50%, and uses the large droplets with the percentage of usage of 100% at the input level of 100%. As illustrated in FIG. 14, the output level is substantially linearly changed with respect to the input level to form a smooth gradation pattern.

As described above, even when the discharge volume of the liquid droplets is the same, the liquid discharge apparatus of the first embodiment can provide the wide intervals between the discharged droplets by increasing the percentage of usage of the large droplets. As a result, the deterioration of the image quality due to the airflow can be reduced.

### Second Embodiment

In the present embodiment, the liquid discharge apparatus is applied to an electrode manufacturing apparatus for manufacturing an electrode and an electrochemical element. The electrode manufacturing apparatus is described below.

FIG. 15 is a schematic view of an electrode manufacturing apparatus using a liquid discharge apparatus according to a second embodiment of the present disclosure. The electrode manufacturing apparatus is an apparatus for manufacturing an electrode including a layer containing an electrode material by discharging a liquid composition using a head module including a liquid discharge head.

### Device for Forming Layer Containing Electrode Material and Process of Forming Layer Containing Electrode Material

A discharge device in the electrode manufacturing apparatus illustrated in FIG. 15 is the head module according to the above-described embodiments of the present disclosure. The liquid discharge head of the head module discharges a liquid composition. By so doing, the liquid composition is applied onto an object, and a liquid composition layer is formed on the object. The object, which may also be referred to as a discharge target in the following description, is not limited to any particular object and may be appropriately selected depending on the intended purpose, as long as the object is an object on which a layer containing an electrode material is to be formed. Examples of the object include an electrode substrate, i.e., a current collector, an active material layer, and a layer containing a solid electrode material. The object may be an electrode composite layer containing an active material on an electrode substrate, i.e., a current collector. The discharge device and a discharge process may be a device and a process of forming a layer containing an electrode material by directly discharging a liquid composition as long as the layer containing an electrode material can be formed on a discharge target. The discharge device and the discharge process may be a device and a process of forming a layer containing an electrode material by indirectly discharging a liquid composition.

### Other Devices and Other Processes

Other configurations included in the electrode manufacturing apparatus for manufacturing an electrode composite layer are not limited to any particular configuration and may be appropriately selected depending on the intended purpose, as long as the effects of the present embodiment are not impaired. Other processes included in the method for manufacturing an electrode composite layer are not limited to any particular process and may be appropriately selected depending on the intended purpose, as long as the effects of the present embodiment are not impaired. For example, a heating device and a heating process are examples of the configuration and the process included in the electrode manufacturing apparatus and the manufacturing method of the electrode composite layer.

### Heating Device and Heating Process

The heating device included the electrode manufacturing apparatus for manufacturing an electrode composite layer is a device that heats the liquid composition discharged by the discharge device. The heating process included in the manufacturing method for manufacturing an electrode composite layer is a process of heating the liquid composition discharged in the discharge process. The liquid composition is heated to dry the liquid composition layer.

### Structure to Form Layer Containing Electrode Material by Direct Discharge of Liquid Composition

As an example of the electrode manufacturing apparatus, an electrode manufacturing apparatus that forms an electrode composite layer containing an active material on an electrode substrate, i.e., a current collector, is described below. As illustrated in FIG. 15, the electrode manufacturing apparatus includes a discharge process device 110 and a heating process device 130. The discharge process device 110 performs a discharge process of applying a liquid composition onto a printing base material 704 having a discharge target to form a liquid composition layer. The heating process device 130 performs a heating process of heating the liquid composition layer to obtain an electrode composite layer.

The electrode manufacturing apparatus includes a conveyor 705 that conveys the printing base material 704. The conveyor 705 conveys the printing base material 704 to the discharge process device 110 and the heating process device 130 in this order at a preset speed. A method of producing the printing base material 704 having the discharge target such as an active material layer is not limited to any particular method, and a known method can be appropriately selected. The discharge process device 110 includes a liquid discharge head 281a (an example of a liquid discharge head) that performs an application process of applying the liquid composition onto the printing base material 704, a storage container 281b that stores a liquid composition 707, and a supply tube 281c that supplies the liquid composition 707 stored in the storage container 281b to the liquid discharge head 281a.

The discharge process device 110 discharges the liquid composition 707 from the liquid discharge head 281a so that the liquid composition 707 is applied onto the printing base material 704 to form a liquid composition layer in a thin film shape. The storage container 281b may be integrated with the electrode manufacturing apparatus that forms the electrode composite layer or may be detachable from the electrode manufacturing apparatus. The storage container 281b may be a container additionally attachable to a container integrated with the electrode manufacturing apparatus for manufacturing the electrode composite layer or to a container detachable from the electrode manufacturing apparatus for manufacturing the electrode composite layer. The storage container 281b that stably stores the liquid composition 707 and the supply tube 281c that stably supplies the liquid composition 707 can be used.

The heating process device 130 performs a solvent removal process of heating and removing the solvent remaining in the liquid composition layer. Specifically, the solvent that remains in the liquid composition layer is heated and dried by a heating device 703 of the heating process device 130. Accordingly, the solvent is removed from the liquid composition layer. Thus, the electrode composite layer is formed. The heating process device 130 may perform the solvent removing process under reduced pressure.

The heating device 703 is not limited to any particular heater and may be appropriately selected depending on the intended purpose. For example, the heating device 703 may be a substrate heater, an infrared (IR) heater, or a hot air heater. The heating device 703 may be a combination of at least two of the substrate heater, the IR heater, and the hot air heater. A heating temperature and heating time can be appropriately selected according to the boiling point of the solvent contained in the liquid composition 707 or the thickness of a formed film.

The electrode manufacturing apparatus according to the present embodiment is used to discharge the liquid composition to a desired position on the discharge target. The electrode composite layer can be suitably used, for example, as a part of the configuration of an electrochemical element. The configuration of the electrochemical element other than the electrode composite layer is not limited to any particular configuration, and a known configuration can be appropriately selected. Examples of the configuration other than the electrode composite layer include a positive electrode, a negative electrode, and a separator.

As described above, the liquid discharge apparatus according to the second embodiment achieves the same effects as those in the first embodiment.

The programs executed by the image forming apparatus 100 is preinstalled and provided in, for example, the ROM 103. Alternatively, the programs executed by the image forming apparatus 100 may be stored, in an installable or executable file format, in a computer readable recording medium, such as a compact disc read only memory (CD-ROM), a flexible disk (FD), a compact disc recordable (CD-R), and a digital versatile disc (DVD).

Alternatively, the programs executed by the image forming apparatus 100 may be stored in a computer connected to a network such as the Internet and downloaded via the network. The programs executed by the image forming apparatus 100 may be provided or distributed via a network such as the Internet.

The programs executed by the image forming apparatus 100 has a modular configuration including the above-described units (an example of the controller as circuitry). An example of a processor, such as the CPU 102, serving as actual hardware reads the programs from the ROM 103 described above and executes the programs so as to load these units described above on a main storage device to implement the example of the controller on the main storage device.

Although the image forming apparatus according to the above-described embodiment is the wide, serial-type inkjet recording apparatus or the electrode manufacturing apparatus, aspects of this disclosure are applicable to any image forming apparatus such as a multifunction peripheral having at least two functions of copying, printing, scanning, and facsimile transmission, a copier, a printer, a scanner, or a facsimile machine.

Aspects of the present disclosure are, for example, as follows.

### Aspect 1

A liquid discharge apparatus includes a liquid discharge head and a controller. The liquid discharge head can discharge two or more kinds of liquid droplets having different sizes. The controller causes the liquid discharge head to discharge only a largest droplet in a high gradation portion of an input gradation value, and to include at least one portion in which a ratio of non-discharge nozzles, which do not discharge the liquid droplets among nozzles of the liquid discharge head, does not increase from a low gradation portion toward the high gradation portion of the input gradation value and a slope of the ratio of non-discharge nozzles does not change.

In other words, a liquid discharge apparatus includes a liquid discharge head and circuitry. The liquid discharge head has multiple nozzles to discharge liquid droplets from the multiple nozzles on a medium to form an image on the medium. The circuitry causes the liquid discharge head to discharge two or more types of the liquid droplets having at least: a first droplet having a first discharge volume; a second droplet having a second discharge volume smaller than the first discharge volume; and a non-discharge droplet not discharged from the multiple nozzles, to form the image on the medium according to an input gradation value of the image. The input gradation value increases from a first range to a second range higher than the first range. Further, the circuitry causes the liquid discharge head to increase a first number of the multiple nozzles that discharge the first droplet in the second range in the input gradation value while decreasing a second number of the multiple nozzles that discharge the non-discharge droplet with an increase in the input gradation value, and causes the liquid discharge head to keep a constant ratio of the second number of the multiple nozzles to a total number of the multiple nozzles in at least one part of the first range in the input gradation value.

In addition, the circuitry is further configured causes the liquid discharge head to discharge the largest droplet of the two or more types of the liquid droplets as the first droplet and causes the liquid discharge head not to discharge the second droplet of the two or more types of the liquid droplets in the second range in the input gradation value of 50% or more.

### Aspect 2

In the liquid discharge apparatus according to Aspect 1, the controller does not decrease a discharged droplet amount ratio, which is an adhesion amount of the liquid droplets per unit area or an image density, as the input gradation value increases.

In other words, the circuitry causes the liquid discharge head to form, on the medium, the image having the image density (linearly) increased with the increase in the input gradation value.

Alternately, the circuitry causes the liquid discharge head to increase an amount of the liquid droplets adhered on the medium per unit area of the medium with the increase in the input gradation value.

### Aspect 3

In the liquid discharge apparatus according to Aspect 1 or 2, the controller causes the liquid discharge head to discharge the smallest droplet only at the input gradation value of 20% or less.

In other words, the circuitry causes the liquid discharge head to discharge the smallest droplet of the two or more types of the liquid droplets as the second droplet in the first range in the input gradation value of 20% or less.

### Aspect 4

In the liquid discharge apparatus according to any one of Aspects 1 to 3, the controller causes the liquid discharge head to discharge only the smallest droplet at the input gradation value of 5% or less.

In other words, the circuitry is causes the liquid discharge head to discharge the smallest droplet of the two or more types of the liquid droplets as the second droplet and causes the liquid discharge head not to discharge the first droplet of the two or more types of the liquid droplets in the first range in the input gradation value of 5% or less.

### Aspect 5

In the liquid discharge apparatus according to Aspect 3, the liquid discharge head can discharge three or more kinds of liquid droplets having different sizes. The controller causes the liquid discharge head to discharge a second smallest droplet at the input gradation value of 20% or less.

In other words, the circuitry causes the liquid discharge head to discharge three or more types of the liquid droplets having: the first droplet having the first discharge volume; the second droplet having the second discharge volume smaller than the first discharge volume; a third droplet having a third discharge volume smaller than the first discharge volume and larger than the second discharge volume; and the non-discharge droplet not discharged from the multiple nozzles. Further, the circuitry causes the liquid discharge head to discharge the second smallest droplet of the three or more types of the liquid droplets as the third droplet in the first range in the input gradation value of 20% or less.

### Aspect 6

In the liquid discharge apparatus according to Aspect 1 or 2, the controller causes at least one portion of the portions in which the slope of the ratio does not change in the liquid discharge head to be present at the input gradation value of 20% or less.

In other words, the at least one part of the first range in the input gradation value includes one range. The circuitry sets the one range in the input gradation value of 20% or less.

### Aspect 7

In the liquid discharge apparatus according to Aspect 1 or 2, the controller causes two portions of the portions in which the slope of the ratio does not change in the liquid discharge head to be present at the input gradation value of 40% or less, and causes one of the two portions to be present at the input gradation value of 20% or less.

In other words, the at least one part of the first range in the input gradation value includes two ranges. The circuitry sets the two ranges in the input gradation value of 40% or less and sets one of the two ranges in the input gradation value of 20% or less.

### Aspect 8

An image forming apparatus includes the liquid discharge apparatus according to any one of Aspects 1 to 7.

In other words, an image forming apparatus includes the liquid discharge apparatus according to any one of Aspects 1 to 7, to form the image on the medium and a conveyor to convey the medium to the liquid discharge head.

### Aspect 9

A liquid discharge method is executed by a liquid discharge apparatus including a liquid discharge head that can discharge two or more kinds of liquid droplets having different sizes. The liquid discharge method includes a step of discharging only a largest droplet in a high gradation portion of an input gradation value and a step of including at least one portion in which a ratio of non-discharge nozzles, which do not discharge the liquid droplets among nozzles of the liquid discharge head, does not increase from a low gradation portion toward the high gradation portion of the input gradation value and a slope of the ratio of non-discharge nozzles does not change.

In other words, a liquid discharge method includes discharging liquid droplets from multiple nozzles on a medium to form an image on the medium and discharging two or more types of the liquid droplets having at least: a first droplet having a first discharge volume; a second droplet having a second discharge volume smaller than the first discharge volume; and a non-discharge droplet not discharged from the multiple nozzles, to form the image on the medium according to an input gradation value of the image. The input gradation value increases from a first range to a second range higher than the first range. The method further includes increasing a first number of the multiple nozzles that discharge the first droplet in the second range in the input gradation value while decreasing a second number of the multiple nozzles that discharge the non-discharge droplet with an increase in the input gradation value, and keeping a constant ratio of the second number of the multiple nozzles to a total number of the multiple nozzles in at least one part of the first range in the input gradation value.

### Aspect 10

A program causes a computer to function as a controller. The computer controls a liquid discharge apparatus including a liquid discharge head that can discharge two or more kinds of liquid droplets having different sizes. The controller causes the liquid discharge head to discharge only a largest droplet in a high gradation portion of an input gradation value, and to include at least one portion in which a ratio of non-discharge nozzles, which do not discharge the liquid droplets among nozzles of the liquid discharge head, does not increase from a low gradation portion toward the high gradation portion of the input gradation value and a slope of the ratio of non-discharge nozzles does not change.

In other words, a non-transitory storage medium stores a plurality of instructions which, when executed by one or more processors, causes the one or more processors to perform a method. The method includes discharging liquid droplets from multiple nozzles on a medium to form an image on the medium and discharging two or more types of the liquid droplets having at least: a first droplet having a first discharge volume; a second droplet having a second discharge volume smaller than the first discharge volume; and a non-discharge droplet not discharged from the multiple nozzles, to form the image on the medium according to an input gradation value of the image. The input gradation value increases from a first range to a second range higher than the first range. The method further includes increasing a first number of the multiple nozzles that discharge the first droplet in the second range in the input gradation value while decreasing a second number of the multiple nozzles that discharge the non-discharge droplet with an increase in the input gradation value, and keeping a constant ratio of the second number of the multiple nozzles to a total number of the multiple nozzles in at least one part of the first range in the input gradation value.

As described above, according to one aspect of the present disclosure, even when the discharge volume of the liquid droplets is the same, the wide intervals between the discharged droplets can be provided by increasing the percentage of usage of the large droplets. As a result, the deterioration of the image quality due to the airflow can be reduced.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, ASICs (“Application Specific Integrated Circuits”), FPGAs (“Field-Programmable Gate Arrays”), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of a FPGA or ASIC.

1. A liquid discharge apparatus comprising:
a liquid discharge head having multiple nozzles to discharge liquid droplets from the multiple nozzles on a medium to form an image on the medium; and
circuitry configured to:
cause the liquid discharge head to discharge two or more types of the liquid droplets having at least:
a first droplet having a first discharge volume;
a second droplet having a second discharge volume smaller than the first discharge volume; and
a non-discharge droplet not discharged from the multiple nozzles,
to form the image on the medium according to an input gradation value of the image, the input gradation value increasing from a first range to a second range higher than the first range;
cause the liquid discharge head to increase a first number of the multiple nozzles that discharge the first droplet in the second range in the input gradation value while decreasing a second number of the multiple nozzles that discharge the non-discharge droplet with an increase in the input gradation value; and
cause the liquid discharge head to keep a constant ratio of the second number of the multiple nozzles to a total number of the multiple nozzles in at least one part of the first range in the input gradation value.

2. The liquid discharge apparatus according to claim 1,
wherein the circuitry is further configured to:
cause the liquid discharge head to discharge the largest droplet of the two or more types of the liquid droplets as the first droplet; and
cause the liquid discharge head not to discharge the second droplet of the two or more types of the liquid droplets,
in the second range in the input gradation value of 50% or more.

3. The liquid discharge apparatus according to claim 1,
wherein the circuitry is further configured to cause the liquid discharge head to form, on the medium, the image having an image density increased with the increase in the input gradation value.

4. The liquid discharge apparatus according to claim 3,
wherein the circuitry is further configured to cause the liquid discharge head to form, on the medium, the image having the image density linearly increased with the increase in the input gradation value.

5. The liquid discharge apparatus according to claim 1,
wherein the circuitry is further configured to cause the liquid discharge head to increase an amount of the liquid droplets adhered on the medium per unit area of the medium with the increase in the input gradation value.

6. The liquid discharge apparatus according to claim 1,
wherein the circuitry is further configured to:
cause the liquid discharge head to discharge the smallest droplet of the two or more types of the liquid droplets as the second droplet in the first range in the input gradation value of 20% or less.

7. The liquid discharge apparatus according to claim 1,
wherein the circuitry is further configured to:
cause the liquid discharge head to discharge the smallest droplet of the two or more types of the liquid droplets as the second droplet; and
cause the liquid discharge head not to discharge the first droplet of the two or more types of the liquid droplets,
in the first range in the input gradation value of 5% or less.

8. The liquid discharge apparatus according to claim 6,
wherein the circuitry is further configured to:
cause the liquid discharge head to discharge three or more types of the liquid droplets having:
the first droplet having the first discharge volume;
the second droplet having the second discharge volume smaller than the first discharge volume;
a third droplet having a third discharge volume smaller than the first discharge volume and larger than the second discharge volume; and
the non-discharge droplet not discharged from the multiple nozzles; and
cause the liquid discharge head to discharge the second smallest droplet of the three or more types of the liquid droplets as the third droplet in the first range in the input gradation value of 20% or less.

9. The liquid discharge apparatus according to claim 1,
wherein the at least one part of the first range in the input gradation value includes one range, and
the circuitry is further configured to set the one range in the input gradation value of 20% or less.

10. The liquid discharge apparatus according to claim 1,
wherein the at least one part of the first range in the input gradation value includes two ranges, and
the circuitry is further configured to:
set the two ranges in the input gradation value of 40% or less; and
set one of the two ranges in the input gradation value of 20% or less.

11. An image forming apparatus comprising:
the liquid discharge apparatus according to claim 1, to form the image on the medium; and
a conveyor to convey the medium to the liquid discharge head.

12. A liquid discharge method comprising:
discharging liquid droplets from multiple nozzles on a medium to form an image on the medium;
discharging two or more types of the liquid droplets having at least:
a first droplet having a first discharge volume;
a second droplet having a second discharge volume smaller than the first discharge volume; and
a non-discharge droplet not discharged from the multiple nozzles,
to form the image on the medium according to an input gradation value of the image, the input gradation value increasing from a first range to a second range higher than the first range;
increasing a first number of the multiple nozzles that discharge the first droplet in the second range in the input gradation value while decreasing a second number of the multiple nozzles that discharge the non-discharge droplet with an increase in the input gradation value; and
keeping a constant ratio of the second number of the multiple nozzles to a total number of the multiple nozzles in at least one part of the first range in the input gradation value.

13. A non-transitory storage medium storing a plurality of instructions which, when executed by one or more processors, causes the one or more processors to perform a method, comprising:
discharging liquid droplets from multiple nozzles on a medium to form an image on the medium;
discharging two or more types of the liquid droplets having at least:
a first droplet having a first discharge volume;
a second droplet having a second discharge volume smaller than the first discharge volume; and
a non-discharge droplet not discharged from the multiple nozzles,
to form the image on the medium according to an input gradation value of the image, the input gradation value increasing from a first range to a second range higher than the first range;
increasing a first number of the multiple nozzles that discharge the first droplet in the second range in the input gradation value while decreasing a second number of the multiple nozzles that discharge the non-discharge droplet with an increase in the input gradation value; and
keeping a constant ratio of the second number of the multiple nozzles to a total number of the multiple nozzles in at least one part of the first range in the input gradation value.
